(19) United States
(12) Patent Application Publication
(10) Pub. No.: US 2024/0410737 A1
(43) Pub. Date: Dec. 12, 2024

(54) EXTERIOR GAUGE COMPONENT WITH ROTARY ENCODER WHEEL AND OPTICAL SENSOR FOR DETECTING LIQUID LEVEL OF TANK

(71) Applicant: SERVICE INSIGHT LLC, Madison, CT (US)

(72) Inventors: Anthony Uzzo, Madison, CT (US); James Gregory, Clinton, CT (US); Edward Davis, Old Saybrook, CT (US); Jeff Seese, Waukee, IA (US); Tim Repp, Barkhamsted, CT (US); Dante Fasano, Guilford, CT (US)

(21) Appl. No.: 18/795,022

(22) Filed: Aug. 5, 2024

Related U.S. Application Data
(63) Continuation of application No. 17/894,639, filed on Aug. 24, 2022.
(60) Provisional application No. 63/236,554, filed on Aug. 24, 2021.

(51) Int. Cl. G01F 23/38; G01D 5/56; G01D 5/58

(52) U.S. Cl. CPC G01F 23/38; G01D 5/56; G01D 5/58

(57) ABSTRACT

A tank includes an interior magnetic float assembly for detecting a liquid level in the tank, and an exterior gauge component attached to a gauge head of the tank for detecting and indicating the liquid level of the tank based on a rotational orientation of a tank magnet of the magnetic float assembly. An adapter plate mounts a housing base of the exterior gauge component to the gauge head. The adapter plate is secured to the housing base and snaps onto the gauge head. A portion of the base defined by a first molded piece extends within an opening of the adapter plate and a second molded piece of the base extends from the opening away from the housing to define a proximal end portion of the housing disposed proximate the tank magnet. Alternatively, the base receives a threaded adapter for mounting to a threaded opening of a gauge head.

### COPYRIGHT STATEMENT

Any new and original work of authorship in this document is subject to copyright protection under the copyright laws of the United States and other countries. Reproduction by anyone of this document as it appears in official governmental records is permitted, but otherwise all other copyright rights whatsoever are reserved.

### BACKGROUND OF THE INVENTION

The invention generally relates to gauges for indicating liquid levels in tanks and, in particular, to such gauges that utilize alternative mechanisms to Hall sensors.

Use of Hall sensors in exterior gauge components in order to determine the level of liquid in a tank having a gauge head with a tank magnet is well known and disclosed, for example, in U.S. Pat. No. 6,564,632, the disclosure of which is incorporated herein by reference. While such exterior gauge components are suitable for their intended use, it is believed that improvement thereover is desirable. One or more embodiments in accordance with one or more aspects and features of the invention are believed to provide just such improvement.

### SUMMARY OF THE INVENTION

The invention includes many aspects and features. Moreover, while many aspects and features relate to, and are described in, the context of liquified petroleum (LP) gas tanks, the invention is not limited to use only in such context, as will become apparent from the following summaries and detailed descriptions of aspects, features, and one or more embodiments of the invention.

For instance, one or more embodiments of the invention may be utilized to determine levels of other substances including, by way of example and not limitation: fuel, diesel fuel, gasoline, hydraulic oil, lubricating oil, water, chemicals, refrigerants, liquified gases such as propane, butane, ammonia, Freon, carbon dioxide, sulphur dioxide, helium, nitrous oxide, oxygen, argon, grains, and liquid waste products. Other contemplated contexts of use of embodiments of the invention include contexts in which float level gauges are utilized, including with compressors, generators, agricultural and construction machinery, boats, IBC containers, domestic tanks, cylinders, storage tanks, trucks, and trailers. Moreover, gauge mounting may be top, bottom, side, end, or at an angle.

Accordingly, in an aspect of the invention, an exterior gauge component for indicating a liquid level of a tank based on a rotational orientation of a tank magnet, which tank magnet is located inside of the tank proximate a gauge head of the tank, comprises: a rotary encoder wheel; an optical sensor configured to determine the rotational orientation of the rotary encoder wheel; a processing unit configured to determine an indication of the liquid level of the tank based on the determined rotational orientation of the rotary encoder wheel; and a communications component configured to communicate information regarding the determined indication of the liquid level of the tank.

In features of this aspect, the rotary encoder wheel is configured to magnetically couple with the interior tank magnet and rotate with rotation of the tank magnet to reveal the rotational orientation of the interior tank magnet. Specific ranges of rotational orientation of the interior tank magnet each corresponds to a respective indication of the liquid level of the tank. The rotational orientation of the rotary encoder wheel—and thus the rotational orientation of the interior tank magnet—is determined using the optical sensor, and the respective indication of the liquid level of the tank is determined by the processing unit as a function of the determined rotational orientation of the rotary encoder wheel.

The communications component in turn communicates information regarding the determined indication of the liquid level of the tank. Such communications may comprise electronically transmitting data regarding the indication; causing an electronic display to show the indication; controlling a mechanical display to show the indication; or any combination thereof. Data that is electronically transmitted may be wirelessly transmitted and may include data regarding rotational orientation of the rotary encoder wheel.

In a feature of this aspect, the exterior gauge component further comprises a display configured to show the indication of the liquid level of the tank that is determined based on the rotational orientation of the rotary encoder wheel.

In a feature of this aspect, the exterior gauge component further comprises a transceiver configured to wirelessly communicate information regarding the indication of the liquid level of the tank that is determined based on the rotational orientation of the rotary encoder wheel.

In another aspect of the invention, an exterior gauge component for indicating a liquid level of a tank based on a rotational orientation of a tank magnet, which tank magnet is located inside of the tank proximate a gauge head of the tank, comprises: (a) a rotary encoder wheel; (b) an optical sensor configured to determine the rotational orientation of the rotary encoder wheel; and (c) a communications component configured to communicate information regarding the determined rotational orientation of the rotary encoder wheel. In this aspect, the indication of the liquid level of the tank may not be determined at the exterior gauge component, but rather at a different, remote location based on the receipt of the information regarding the rotational orientation of the rotary encoder wheel that is determined by and communicated from the external gauge component.

In a feature of these aspects, the exterior gauge component comprises a multi-track rotary encoder wheel. In an alternative feature, the exterior gauge component comprises a single-track rotary encoder wheel.

In a feature of these aspects, each track of a multi-track rotary encoder wheel represents a binary bit of an output that is read by the optical sensor. Preferably, the optical sensor comprises photocells for reading the tracks. One or more illumination elements further preferably are utilized, as the rotary encoder wheel may be contained within the housing of the exterior gauge component and shielded from ambient light. An exemplary illumination element or light source comprises one or more LEDs.

In a feature of these aspects, the rotary encoder wheel is attached to a shaft of a magnet assembly, the magnet assembly comprising magnets located proximate an exterior wall of a proximal end of the exterior gauge component for magnetic coupling of the magnets of the magnet assembly with the interior tank magnet at the gauge head.

In a feature of these aspects, a multi-track rotary encoder wheel comprises three tracks for providing eight different indications of the liquid level in the tank.

In a feature of these aspects, a multi-track rotary encoder wheel comprises four tracks for providing sixteen different indications of the liquid level in the tank.

In a feature of these aspects, consecutive indications of the liquid level in the tank vary by a uniform amount. Consecutive indications of the liquid level in the tank may vary by an eighth of a tank or may vary by a sixteenth of a tank. Alternatively, indications of the liquid level in the tank may be more granular at lower liquid levels of the tank. For example, consecutive indications of the liquid level in the tank vary by an eighth of a tank for liquid levels between a full tank and a half-tank; by a sixteenth of a tank between liquid levels of a half-tank and a quarter of a tank; and by one thirty-second of a tank between liquid levels of a quarter of a tank and an empty tank.

In a feature, the exterior gauge component comprises a housing comprising a power source, an antenna, an OLED display, and a printed circuit board assembly including electrical components, the printed circuit board assembly comprising both the optical sensor and wireless transceiver components for wireless communicating indications of the liquid levels of the tank.

Further with respect to this feature, the exterior gauge component comprises an adapter plate secured to a bottom of the housing, and the adapter plate is configured to mount onto a gauge head of a plurality of different tanks for mounting of the housing thereto. The adapter plate also preferably comprises an opening extending completely therethrough from one side to another side of the adapter plate. A proximal end portion of the housing preferably extends within the opening through the adapter plate. When the rotary encoder wheel is attached to a shaft of a magnet assembly, and the magnet assembly comprises magnets, the magnets of the magnet assembly preferably are located within the proximal end portion of the housing that extends within the opening through the adapter plate such that the magnets of the magnet assembly are located proximate an exterior wall of a proximal end of the exterior gauge component for magnetic coupling of the magnets of the magnet assembly with a tank magnet of a gauge head. In some embodiments, the proximal portion of the housing is configured to attach to a threaded adapter, and preferably an NPT adapter, for mounting to a threaded opening of a tank.

In another aspect of the invention, a tank comprises: a magnetic float assembly located entirely inside the tank for detecting a level of a liquid in the tank; and an exterior gauge component attached to a gauge head of the tank and configured to indicate the liquid level of the tank based on a rotational orientation of a tank magnet located at the gauge head.

In particular, the magnetic float preferably comprises a float, a drive shaft connected to the float and rotatably driven by a change in elevation of the float due to a change in level of a liquid in the tank, and the tank magnet located at an end of the shaft proximate the gauge head and rotatably driven by rotation of the drive shaft.

The exterior gauge component preferably comprises a rotary encoder wheel; and an optical sensor configured for reading an output of the rotary encoder wheel. The rotary encoder wheel is configured to rotate with rotation of the tank magnet such that specific ranges of rotational orientation of the tank magnet each corresponds to a specific output of the rotary encoder wheel.

In preferred embodiments, the tank is a liquefied petroleum (LP) gas tank.

In a feature, the exterior gauge component further comprises a display configured to communicate an indication of a liquid level of the tank based on the output of the rotary encoder wheel.

In a feature, the exterior gauge component further comprises a transceiver configured to wirelessly communicate an indication of a liquid level of the tank based on the output of the rotary encoder wheel.

In a feature, the rotary encoder wheel comprises multiple tracks, and each track of the rotary encoder wheel represents a binary bit of an output that is read from the rotary encoder wheel by the optical sensor.

In a feature, the rotary encoder wheel is attached to a shaft of a magnet assembly, the magnet assembly comprising magnets located proximate an exterior wall of a proximal end of the exterior gauge component for magnetic coupling of the magnets of the magnet assembly with a tank magnet at a gauge head.

In a feature, the exterior gauge component further comprises a housing comprising a power source, an antenna, an OLED display, and a printed circuit board assembly including electrical components, the printed circuit board assembly comprising both the optical sensor and wireless transceiver components for wireless communicating indications of the liquid levels of the tank.

Further with respect to this feature, the exterior gauge component comprises an adapter plate secured to a bottom of the housing, and the adapter plate is configured to mount onto a gauge head of the tank for mounting of the housing to the gauge head. The adapter plate also preferably comprises an opening extending completely therethrough from one side to another side of the adapter plate. A proximal end portion of the housing preferably extends within the opening through the adapter plate. When the rotary encoder wheel that is attached to a shaft of a magnet assembly, and the magnet assembly comprises magnets, the magnets of the magnet assembly preferably are located within the proximal end portion of the housing that extends within the opening through the adapter plate such that the magnets of the magnet assembly are located proximate an exterior wall of a proximal end of the exterior gauge component for magnetic coupling of the magnets of the magnet assembly with a tank magnet of a gauge head. In some embodiments, the proximal portion of the housing also is configured to attach to a threaded adapter for mounting to a threaded opening of a tank. For example, embodiments for use with oil preferably comprise a threaded adapter. In other embodiments, there is no threaded adapter. For example, embodiments for use with propane preferably do not comprise a threaded adapter.

Another aspect relates to a method of determining a liquid level of a tank based on a rotational orientation of a tank magnet located inside of the tank proximate a gauge head of the tank. Preferably, the method comprises; (a) attaching an exterior gauge component to the gauge head, the exterior gauge component comprising a rotary encoder wheel and an optical sensor configured for reading an output of the rotary encoder wheel, the rotary encoder wheel being configured to rotate with rotation of the tank magnet such that specific ranges of rotational orientation of the tank magnet each corresponds to a specific output of the rotary encoder wheel; (b) detecting a rotational orientation of the tank magnet by detecting the rotational orientation of the rotary encoder wheel using the optical sensor; and (c) communicating an indication of a liquid level of the tank by the exterior gauge component based on the detected rotational orientation of the rotary encoder wheel.

The tank preferably is liquefied petroleum (LP) gas tank.

In a feature, each track of the rotary encoder wheel represents a binary bit of the output read by the optical sensor.

In a feature, the rotary encoder wheel is attached to a shaft of a magnet assembly, the magnet assembly comprising magnets located proximate an exterior wall of a proximal end of the exterior gauge component extending next to the gauge head for magnetic coupling of the magnets of the magnet assembly with the tank magnet.

In a feature, the step of communicating an indication of the liquid level of the tank comprises displaying, on a display of the exterior gauge component, an indication of the liquid level of the tank based on the output of the rotary encoder wheel.

In a feature, the step of communicating an indication of the liquid level of the tank comprises electronically communicating an indication of the liquid level of the tank based on the output of the rotary encoder wheel.

In a feature, the step of communicating an indication of the liquid level of the tank comprises wirelessly communicating an indication of the liquid level of the tank based on the output of the rotary encoder wheel.

In still another feature of one or more of the foregoing aspects, the rotary encoder wheel comprises a single track and the optical sensor comprises an array of sensors arranged for reading a single track located along an inside of the rotary encoder wheel.

In another feature of one or more of the foregoing aspects, the rotary encoder wheel comprises three tracks for providing eight different indications of the liquid level in the tank.

In still another feature of one or more of the foregoing aspects, the rotary encoder wheel comprises four tracks for providing sixteen different indications of the liquid level in the tank.

In still another feature of one or more of the foregoing aspects, the rotary encoder wheel comprises adjoining areas of different characteristics of imagery and the optical sensor is configured to detect and differentiate each area based on its characteristics of imagery.

In still another feature of one or more of the foregoing aspects, the rotary encoder wheel comprises adjoining areas of different contrasts and the optical sensor is configured to detect and differentiate each area based on its contrast.

In still another feature of one or more of the foregoing aspects, the rotary encoder wheel comprises adjoining areas of different colors and the optical sensor is configured to detect and differentiate each area based on its color.

In still another feature of one or more of the foregoing aspects, the optical sensor comprises one or more digital imagers.

In still another feature of one or more of the foregoing aspects, the optical sensor comprises an array of sensor components, each sensor component configured to detect a ratio of areas within its field of view, and wherein based on the ratio detected for each sensor component, a specific, unique orientation of the wheel is determined, which unique orientation indicates a liquid level in a tank. The ratio may comprise, for example, a ratio of pixels.

In addition to the aforementioned aspects and features of the invention, it should be noted that the invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the invention now will be described in detail with reference to the accompanying drawings.

FIG. 1 is a perspective view of a preferred embodiment of an exterior gauge component in accordance with one or more aspects and features of the invention.

FIG. 1A corresponds to FIG. 1 and is shaded and in color to promote clarity of illustration.

FIG. 2 is an exploded view of the exterior gauge component of FIG. 1 and an adapter plate for mounting of the exterior gauge component to a gauge head of a tank.

FIG. 2A corresponds to FIG. 2 and is shaded and in color to promote clarity of illustration.

FIG. 3 is another exploded view of the exterior gauge component of FIG. 1.

FIG. 3A corresponds to FIG. 3 and is shaded and in color to promote clarity of illustration.

FIG. 4 is a top plan view of a preferred embodiment of a rotary encoder wheel of the exterior gauge component of FIG. 1.

FIG. 5 is the view of the rotary encoder wheel of FIG. 5 in which the sixteen different possible outputs of the rotary encoder wheel are shown, namely, the sixteen different sections of the wheel that correspond to sixteen different indications of tank liquid levels.

FIG. 6 is an exploded view of the housing and the adapter plate of the exterior gauge component of FIG. 1.

FIG. 6A corresponds to FIG. 6 and is shaded and in color to promote clarity of illustration.

FIG. 7 is a perspective view of the base of the exterior gauge component.

FIG. 7A corresponds to FIG. 7 and is shaded and in color to promote clarity of illustration.

FIG. 8 is an exploded view of a threaded adapter and an exterior gauge component of another preferred embodiment in accordance with one or more aspects and features of the invention.

FIG. 8A corresponds to FIG. 8 and is shaded and in color to promote clarity of illustration.

FIG. 9 is an exploded view of the threaded adapter and certain components of the exterior gauge component of FIG. 8.

FIG. 9A corresponds to FIG. 9 and is shaded and in color to promote clarity of illustration.

FIG. 10 is a perspective view of the base of the exterior gauge component of FIG. 8.

FIG. 10A corresponds to FIG. 10 and is shaded and in color to promote clarity of illustration.

FIG. 11 is a simple schematic illustration of an elevational view of a tank including a magnetic float assembly inside the tank for detecting a level of a liquid in the tank and a preferred embodiment of an exterior gauge component for indicating the level of liquid detected, in accordance with one or more aspects and features of the invention.

FIG. 12 is a perspective view of a top of another rotary encoder wheel of a preferred exterior gauge component in accordance with one or more aspects and features of the invention.

FIG. 13 illustrates a single-track rotary encoder wheel in accordance with one or more aspects and features of the invention.

FIG. 14 shows a table demonstrating the mapping of sensor readings of the rotary encoder wheel of FIG. 13 to particular states of the liquid level of the tank, in accordance with one or more aspects and features of the invention.

FIG. 15 illustrates a rotary encoder wheel comprising discrete, adjoining areas of differing contrast by which the areas of differentiated by the optical sensor component, in accordance with one or more aspects and features of the invention.

FIG. 16 illustrates a rotary encoder wheel comprising discrete, adjoining areas of differing densities of dots, by which the areas are differentiated by the optical sensor component.

FIGS. 17-22 illustrate exemplary orientations of the rotary wheel of FIG. 16 as it rotates in a counterclockwise direction, each orientation resulting in a unique set of ratios being determined by the array of eight sensor components, each sensor component detecting a ratio as shown so as to define a unique set of ratios for each given rotation of the wheel.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast, “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

Referring now to the drawings, one or more preferred embodiments of the invention are next described. The following description of one or more preferred embodiments is merely exemplary in nature and is in no way intended to limit the invention, its implementations, or uses.

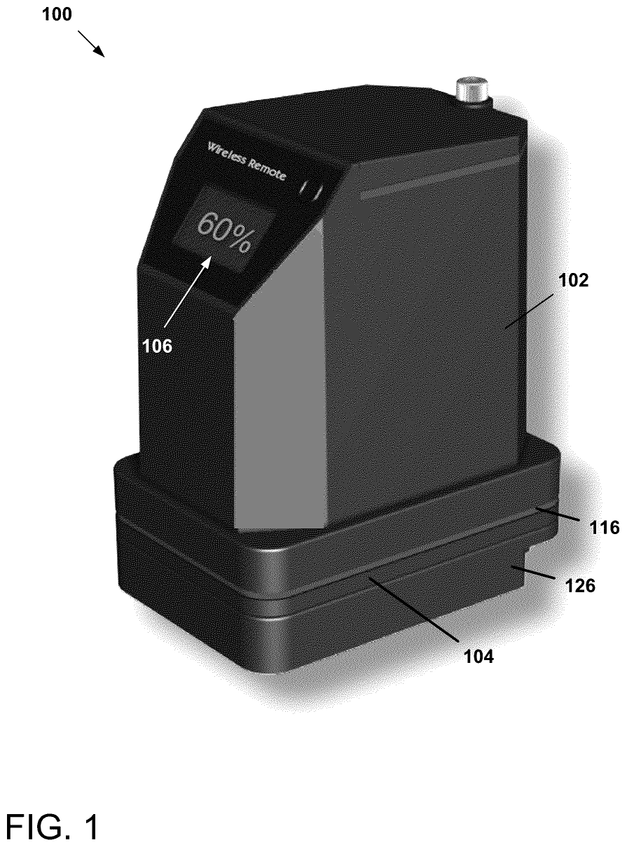

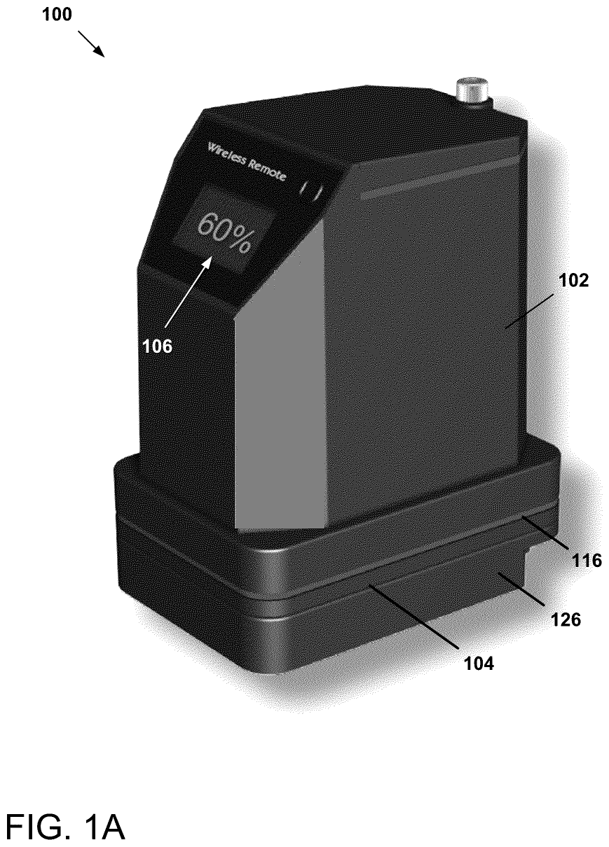

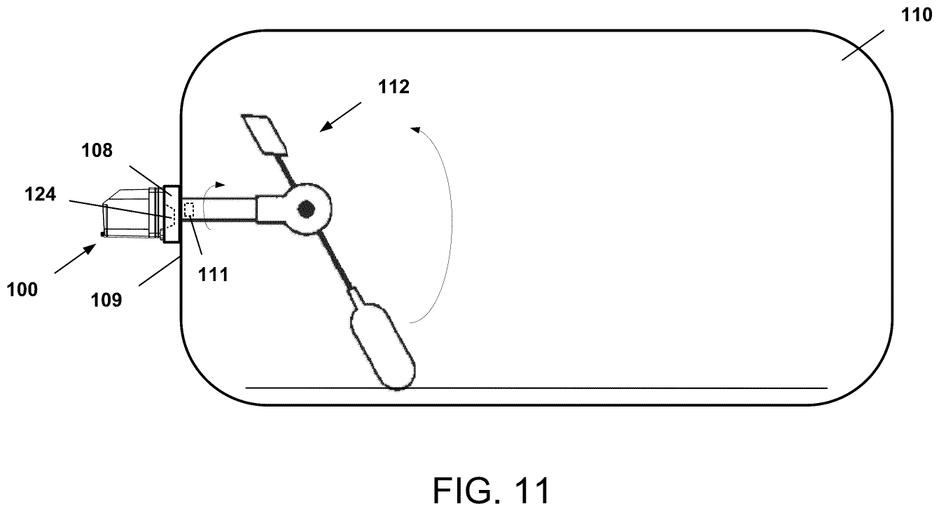

Turning now to FIG. 1, this figure shows a perspective view of a preferred embodiment of an exterior gauge component 100 in accordance with one or more aspects and features of the invention. The exterior gauge component 100 includes a housing 102, an adapter plate 126, and a base 104. Also as perhaps best seen in FIG. 1, the housing includes a display 106 for displaying an indication of a liquid level in a tank when attached to a gauge head of the tank. For clarity of illustration, FIG. 1A is a shaded view in color of the view of FIG. 1. A representative illustration thereof is shown in FIG. 11, where exterior gauge component 100 is attached on exterior wall 109 to gauge head 108 of tank 110. FIG. 11 further shows a magnetic float mechanism 112 including tank magnet 111 contained within the tank 110, in which tank the liquid level is quite low.

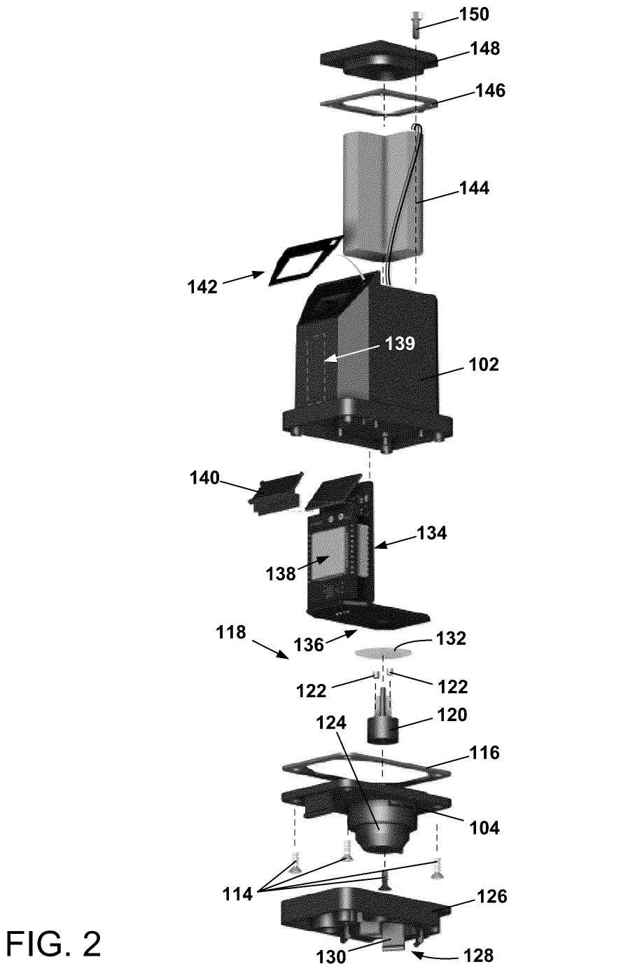

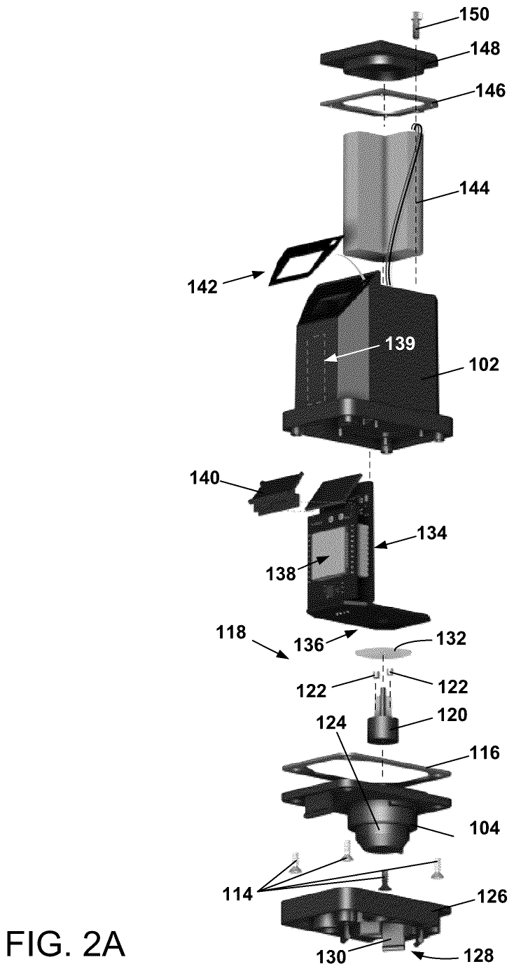

An exploded view of the exterior gauge component 100 and the adapter plate 126 is shown in FIG. 2. As seen therein, the base 104 is removably connected to the housing by screws 114 that extend through a gasket 116 that is sandwiched therebetween. Contained within the housing 102 is a magnet assembly 118 that comprises a shaft 120 with shoulder at a proximal end for receiving and retaining magnets 122. The magnet assembly 118 is located within a distal end portion 124 of the base 104 of the exterior gauge component 100. A rotary encoder wheel 132 is attached to a distal end of the shaft 120 and rotates with the shaft.

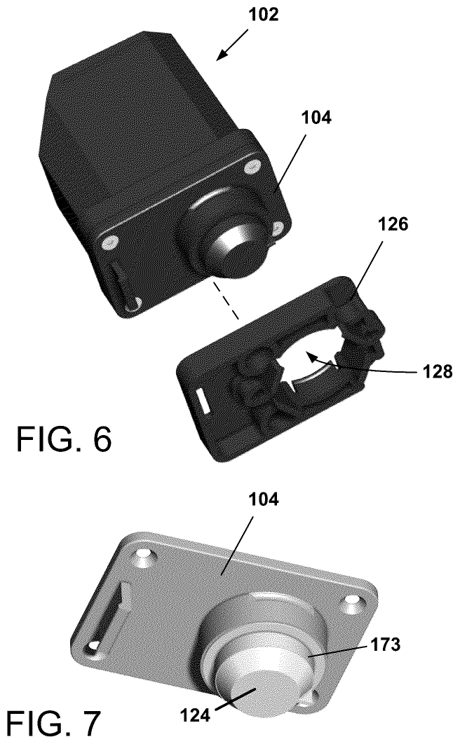

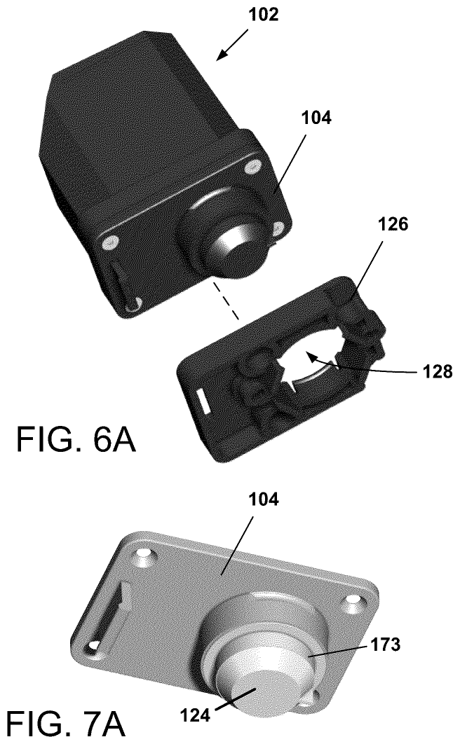

An adapter plate 126 mounts to a gauge head of various tanks and is “universal” in terms of its compatibility with tanks of different manufacturers; the “adapter plate” thus allows the exterior gauge component to be retrofitted on most any propane tank gauge head. The molded piece 173 (shown in FIG. 7) comprising the proximal end portion 124 is received through the opening 128 of the adapter plate 126, and the base 104 frictionally fits within the opening 128 (perhaps best seen in FIG. 6). The adapter plate 126 is used for mounting and dismounting of the exterior gauge component 100 to a tank at the gauge head. The opening 128 extends completely through the adapter plate 126 between opposite sides thereof. The adapter plate further preferably includes retention grips 130 that enable the adapter plate to snap onto a gauge head. When the components are assembled within the housing 102, the distal end portion 124 with magnets 122 located therein extends within the opening 128 extending through the adapter plate 126 for disposition proximate a tank magnet of the gauge head for magnetic coupling therewith such that rotation of the tank magnet results in rotation of the shaft 120 and consequent rotation of the rotary encoder wheel 132.

A printed circuit board assembly 134 is contained within the housing 102 and comprises electrical components including an optical sensor at 136, a wireless transceiver 138 including an embedded antenna 139 in a housing wall, and an OLED display with tactile switch 140 with an overlay 142. The housing 102 further contains a power supply for powering of the electrical components, which power supply preferably comprises three replaceable AA batteries contained in a removable cartridge 144. The cartridge 144 is accessible by removing top panel 148, which is removably retained to the housing 102 by screw 150. A gasket 146 also extends between the panel 148 and housing 102. The gaskets 116,146 serve to prevent moisture and water from entering in the interior of the housing 102. Alternatively, lithium-ion batteries are used instead of AA batteries. Additionally, in some embodiments the removable cartridge, panel, and gasket are omitted whereby the batteries are not replaceable.

For clarity of illustration, FIG. 2A is a shaded view in color of the view of FIG. 2.

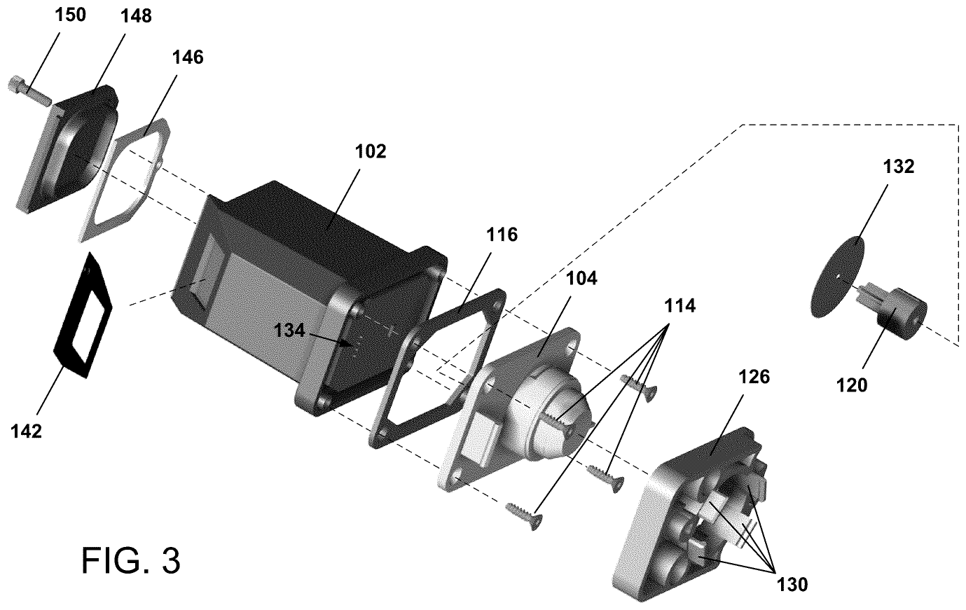

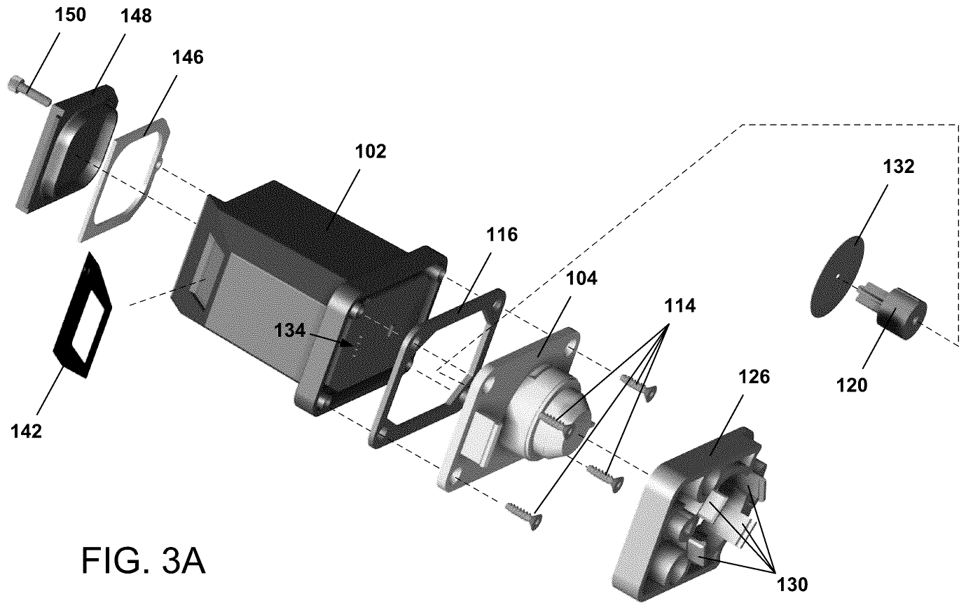

Another exploded view of the exterior gauge component 100 and adapter plate 126 is shown in FIG. 3.

For clarity of illustration, FIG. 3A is a shaded view in color of FIG. 3.

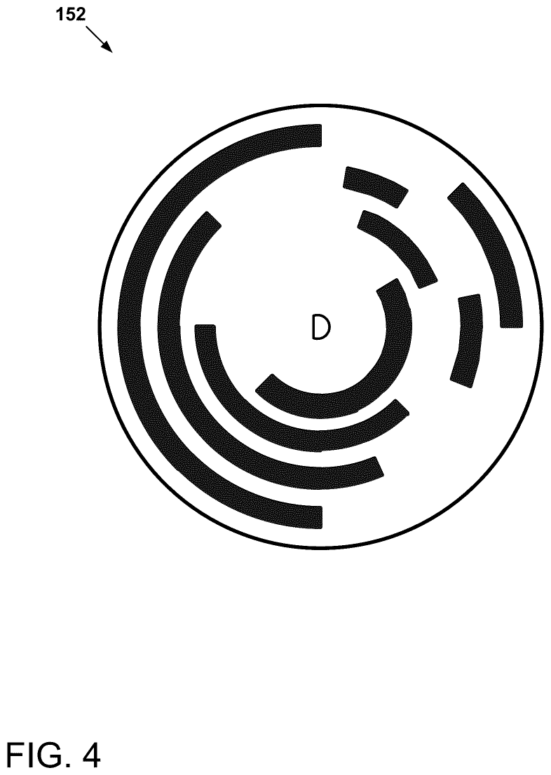

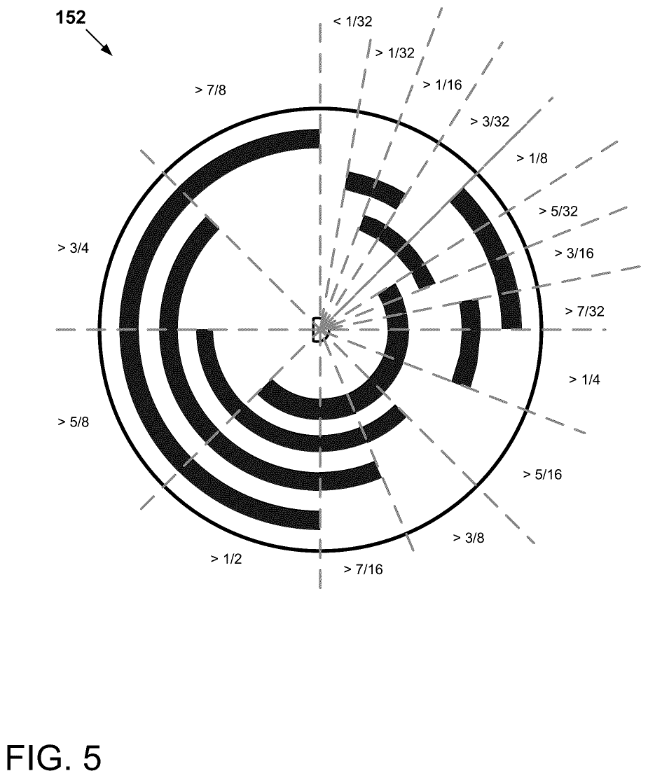

A top plan view of a preferred embodiment of a rotary encoder wheel 152 is shown in FIG. 4. FIG. 5 is the same view of the rotary encoder wheel 152 in which the sixteen different possible outputs of the rotary encoder wheel are shown, namely, the sixteen different sections of the wheel that correspond to sixteen different indications of tank liquid levels, as indicated. The rotary wheel 152 is a Gray code encoder in which changes between consecutive states occur one track (one bit) at a time. Specifically, each track of the rotary encoder wheel represents a binary bit of the output read by the optical sensor. Preferably, the optical sensor comprises photocells for reading the tracks, and one or more illumination elements or light sources to facilitate such reading, as the rotary encoder wheel is contained within the housing of the exterior gauge component. An exemplary illumination element or light source comprises an LED on the printed circuit board.

It will be appreciated that, as shown in FIG. 5, indications of the liquid level in the tank are more granular at lower liquid levels of the tank. In particular, consecutive indications of the liquid level in the tank vary by an eighth of a tank for liquid levels between a full tank and a half-tank; by a sixteenth of a tank between liquid levels of a half-tank and a quarter of a tank; and by one thirty-second of a tank between liquid levels of a quarter of a tank and an empty tank.

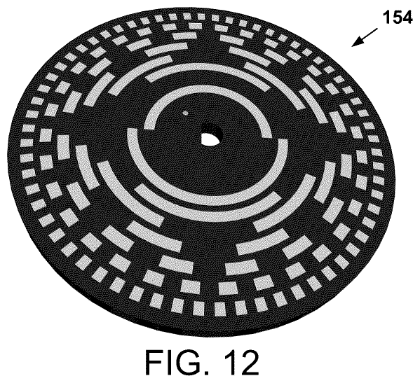

Another rotary encoder wheel 154 is shown in FIG. 12. The rotary encoder wheel 154 is seen to have eight tracks corresponding to eight bits, and thus 256 different outputs may be read from the encoder corresponding to 256 different fluid levels of a tank.

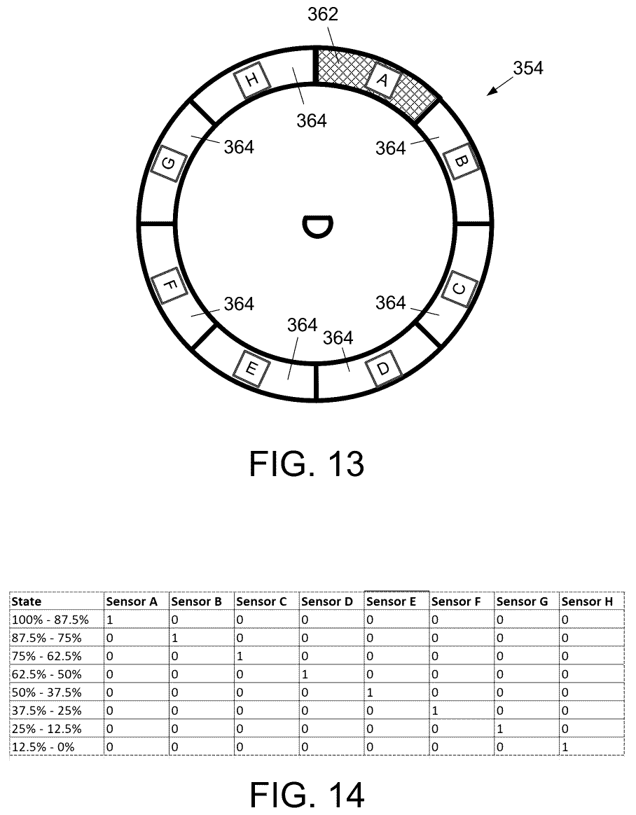

Another variation of the rotary encoder wheel 354 is illustrated in FIG. 13. The rotary encoder wheel 354 is a single-track rotary encoder wheel, wherein the track preferably is located proximate the perimeter or circumference of the wheel.

FIG. 6 is an exploded view of the exterior gauge component 100 and the adapter plate 126.

For clarity of illustration, FIG. 6A is a shaded view in color of FIG. 6.

FIG. 7 is a perspective view of the component that forms the removable base 104 of the housing 102 of the exterior gauge component 100 and perhaps best shows the proximal end portion 124.

For clarity of illustration, FIG. 7A is a shaded view in color of FIG. 7.

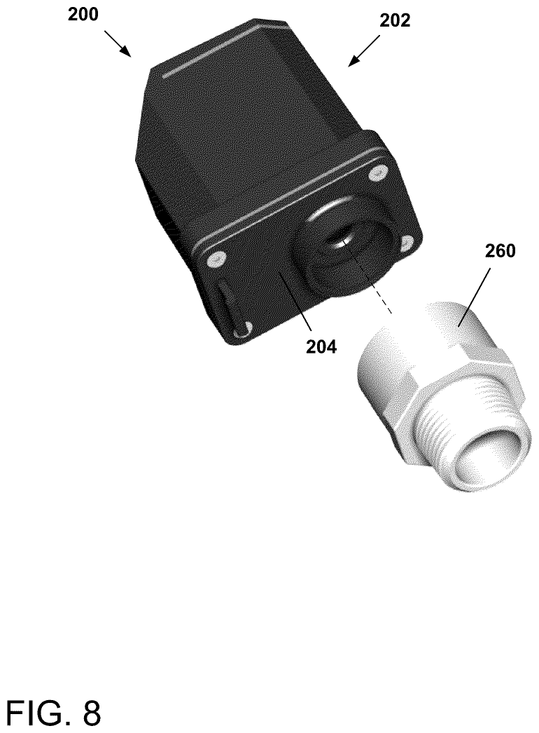

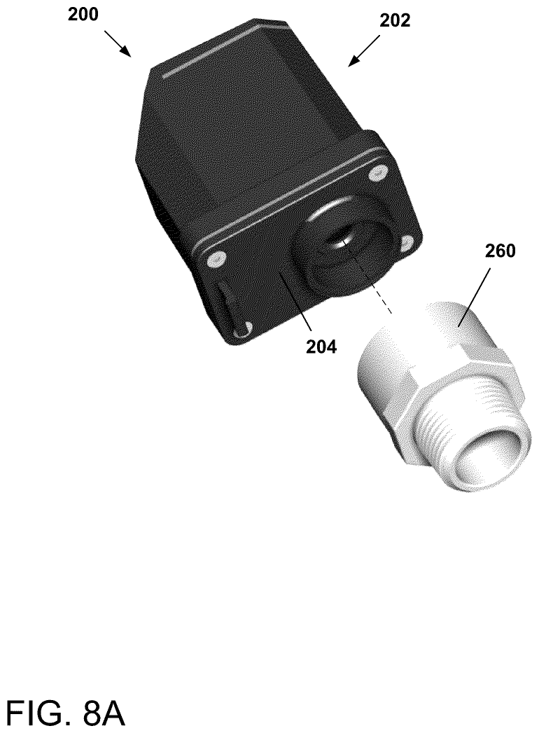

FIG. 8 is an exploded view of a housing 202 and base 204 of another preferred embodiment of an exterior gauge component 200 in accordance with one or more aspects and features of the invention. The exterior gauge component 200 is attachable to a threaded adapter 260 for installation on a threaded opening of a tank, such as an oil tank.

For clarity of illustration, FIG. 8A is a shaded view in color of FIG. 8.

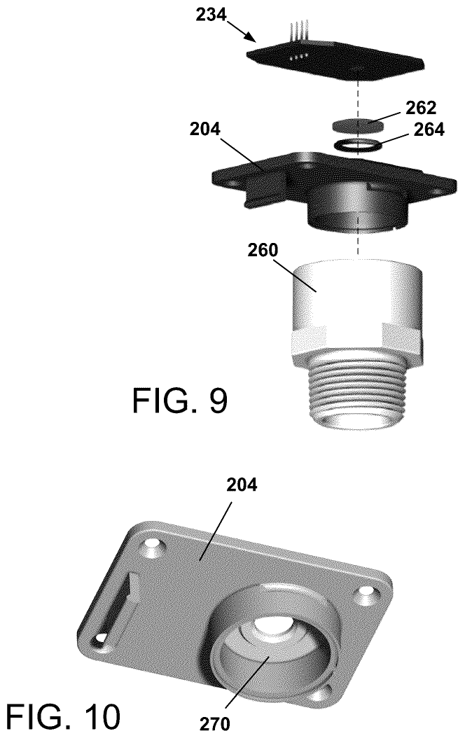

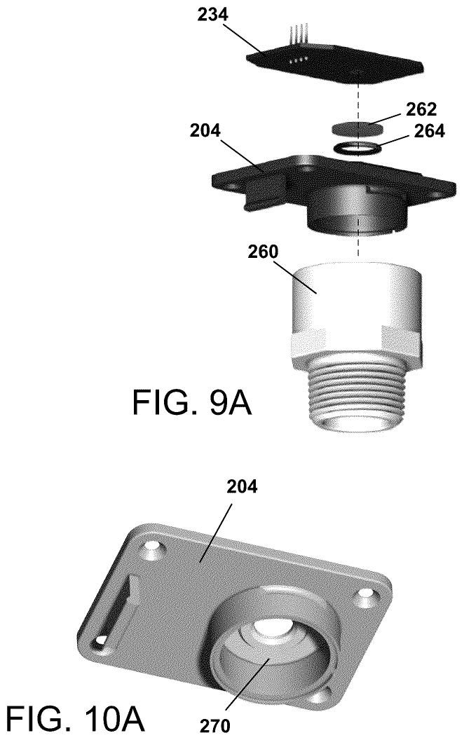

Preferably, the shell of the housing 202 and base 204 are substantially the same as the housing 102 and base 104 with only small modifications—if any, whereby the components are interchangeable when manufacturing exterior gauge components 100,200. The internal components of the housing 202 that differ from the internal components of the housing 102 are best seen in FIG. 9, which is an exploded view of certain components of the housing 202 together with the threaded adapter 260. The internal components that differ include a printed circuit board 234 that includes a laser for measuring a distance from the exterior gauge component to a fluid level in a tank (wherein the exterior gauge component 200 is installed on the top of the tank); a window or lens 262 through which the laser passes; and an O-ring 264.

For clarity of illustration, FIG. 9A is a shaded view in color of FIG. 9.

FIG. 10 is a perspective view of the base 204 of the exterior gauge component 200 and shows a shoulder 270 within an opening of the base 204. The O-ring 264 supports the lens 262 on the shoulder 270 of the base 204 when the exterior gauge component 200 is assembled. The shoulder 270 and the remainder of the base 204 preferably are separate molded pieces. In some embodiments, removal of the shoulder and installation of a different molded piece—indicated by 173 in FIG. 7, preferably results in the base 104 of exterior gauge component 100 seen in these earlier figures.

For clarity of illustration, FIG. 10A is a shaded view in color of FIG. 10.

In operation, the exterior gauge components 100,200 provide indications of the fluid levels in tanks. The indications preferably are wirelessly communicated from the exterior gauge components 100,200 over cellular or Wi-Fi networks to one or more servers connected to the Internet, whereat information is compiled regarding the liquid levels for determining billing for use of the liquids in the tanks and/or for determining when tanks should be refilled and order of priority for refilling tanks.

With regard to operation of each illustrated embodiment 100,200, exterior gauge component 100 determines an indication of the fluid level in a tank by reading the rotational position of the rotary encoder wheel, which corresponds to the rotational position of the tank magnet, which corresponds through the float mechanism to the actual fluid level. In contrast, exterior gauge component 200 determines an indication of the fluid level in a tank by measuring a distance from the exterior gauge component to the top of the fluid contained in the tank using a laser. Exterior gauge components 100,200 also preferably display indications of the fluid levels of tanks through the displays of the housings. Exterior gauge components 100,200 also may electronically transmit indications of fluid levels over wired connections such as CAT cabling.

A variation of embodiment 100 and, specifically, the use of the rotary encoder wheel is now described in connection with FIGS. 13-14. In this variation, the embodiment utilizes is a single-track rotary encoder wheel 354 as schematically represented in FIG. 13. In this respect, the single track extends along the inside periphery of the wheel and there are no concentric rings for reading by the optical sensor. As shown in FIG. 13, the track comprise eight blocks of which one block 362 is black and the other seven blocks 364 are white. The optical sensor used to read the single-track encoder wheel 354 comprises a corresponding sensor array that is arranged for reading the track arranged along the inside of the periphery of the wheel. This arrangement is represented in FIG. 13 by eight sensor components A, B, C, D, E, F, G, H of the array. In use, each of the eight sensor components of the array detects whether block 362 is present at that sensor component, whereby the rotational orientation of the rotary encoder wheel is determined. The wheel preferably moves in a clockwise rotation as the liquid level of a tank decreases, and detection of block 362 by a leading sensor component preferably trumps detection by a trailing sensor component. The table of FIG. 14 demonstrates the state of the liquid level of the tank based on such detection.

When sensor component A detects block 362, the liquid level is determined to be 87.5% to 100% full; when leading sensor component B detects block 362 (irrespective of whether sensor component A—the trailing sensor component—also still detects block 362), the liquid level is determined to be at a state of 75% to 87.5% full; when leading sensor component C detects block 362 (irrespective of whether sensor component B—the trailing sensor component—also still detects block 362), the liquid level is determined to be at a state of 62.5% to 75% full; when leading sensor component D detects block 362 (irrespective of whether sensor component C—the trailing sensor component—also still detects block 362), the liquid level is determined to be at a state of 50% to 62.5% full; when leading sensor component E detects block 362 (irrespective of whether sensor component D—the trailing sensor component—also still detects block 362), the liquid level is determined to be at a state of 37.5% to 50% full; when leading sensor component F detects block 362 (irrespective of whether sensor component E—the trailing sensor component—also still detects block 362), the liquid level is determined to be at a state of 25% to 37.5% full; when leading sensor component G detects block 362 (irrespective of whether sensor component F—the trailing sensor component—also still detects block 362), the liquid level is determined to be at a state of 12.5% to 25% full; and when leading sensor component H detects block 362 (irrespective of whether sensor component G—the trailing sensor component—also still detects block 362), the liquid level is determined to be at a state of less than 12.5% full.

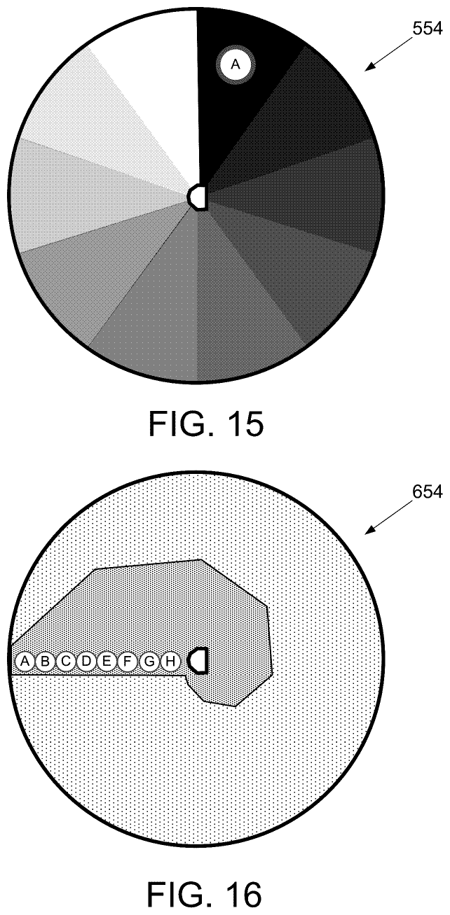

An alternative sensing technique to that illustrated in FIGS. 12-14 is now described with reference to FIG. 15, wherein rotary encoder wheel 554 is shown to have ten separate and discrete adjoining rejoins, with each successive region in a clockwise direction having a decreasing contrast or different color/shade of color, which is sensed by an optical sensor A and utilized to differentiate and detect each of the areas.

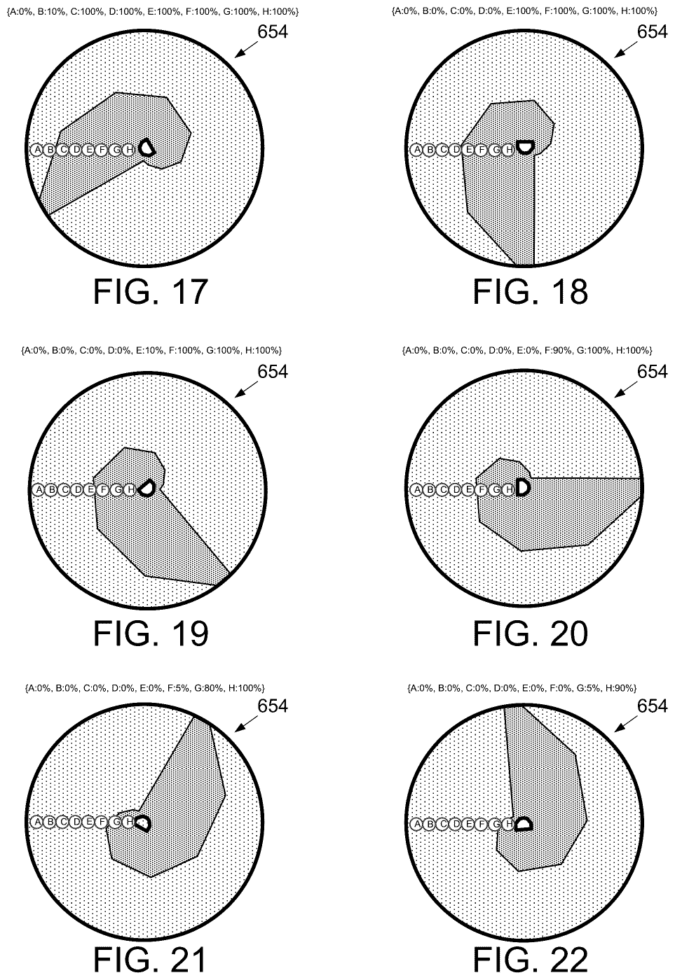

Yet another alternative sensing technique is illustrated in FIG. 16, wherein rotary encoder wheel 654 is shown to be divided into two regions of pixel or dots densities. The optical sensor comprises a sensor array of sensor components A, B, C, D, E, F, G, H. Each sensor component is configured to image a respective portion of the rotary wheel immediately adjacent thereto within its field of vision and a determination is made of the ratio of the two regions imaged within the sensor component's field of view. The ratio may comprise a ratio of dots or pixels, e.g., white pixels to black pixels. Based on the ratio determined for each sensor component, a specific, unique orientation of the wheel can be determined, which unique orientation is used to indicate a liquid level in a tank. For example, FIGS. 17-22 illustrate exemplary orientations of the rotary wheel 654 as it rotates in a counterclockwise direction, each orientation resulting in a unique set of ratios being determined by sensor components A, B, C, D, E, F, G, H.

Based on the foregoing description, it will be readily understood by those persons skilled in the art that the invention has broad utility and application. Many embodiments and adaptations of the invention other than those specifically described herein, as well as many variations, modifications, and equivalent arrangements, will be apparent from or reasonably suggested by the invention and the foregoing descriptions thereof, without departing from the substance or scope of the invention.

Accordingly, while the invention has been described herein in detail in relation to one or more preferred embodiments, it is to be understood that this disclosure is only illustrative and exemplary of the invention and is made merely for the purpose of providing a full and enabling disclosure of the invention. The foregoing disclosure is not intended to be construed to limit the invention or otherwise exclude any such other embodiments, adaptations, variations, modifications or equivalent arrangements, the invention being limited only by the claims appended hereto and the equivalents thereof.

Thus, for example, in a contemplated modification, a dial and a dial face are provided in substitution of the rotary encoder wheel of the aforementioned exterior gauge components, with the dial rotating in conjunction with rotation of the shaft of the exterior gauge component. Furthermore, as part of the printed circuit board assembly, an optical sensor comprising a camera component takes digital pictures of the indication of the liquid level in the tank shown by the dial's location relative to the dial face. Preferably, the camera component takes a digital picture of this indication on a regular basis, such as daily or hourly, and transmits the picture as an image to servers for interpretation by a human or machine learning model. Furthermore, the dial preferably is visible to a person physically at the exterior gauge component for visually reading of the liquid level in the tank by the person. The person may be a service technician or a homeowner.

1-46. (canceled)

47. A tank, comprising:
(a) a magnetic float assembly located inside the tank, the magnetic float assembly comprising a tank magnet located proximate a gauge head of the tank; and
(b) an exterior gauge component attached on an exterior of the tank to the gauge head of the tank;
(c) wherein the exterior gauge component comprises
(i) an antenna,
(ii) a housing to which the antenna is attached, the housing comprising
(A) a power source for powering the exterior gauge component,
(B) an OLED display, and
(C) a printed circuit board assembly contained in an interior of the housing and comprising components connected to the OLED display and connected to the antenna for wirelessly communicating;
(iii) a base attached to the housing and defining a bottom of the housing, the base comprising,
(A) a first molded piece defining an opening through the base to the interior of the housing, and
(B) a second molded piece covering the opening and extending from the first molded piece away from the housing, the second molded piece defining a distal end portion of the base; and
(iv) an adapter plate that is
(A) secured to the base defining the bottom of the housing, and
(B) attached to the gauge head,
by which adapter plate the housing is mounted to the gauge head;
(v) wherein the adapter plate comprises an opening extending completely through the adapter plate; and
(vi) wherein a portion of the base is located within the opening of the adapter plate and extends through the adapter plate for disposition of the distal end portion of the base defined by the second molded piece proximate the tank magnet inside the tank.

48. The tank of claim 47, wherein the magnetic float comprises a float and a drive shaft connected to the float and rotatably driven by a change in elevation of the float due to a change in a level of a liquid in the tank, and wherein the tank magnet is located at an end of the shaft and is rotatably driven by rotation of the drive shaft.

49. The tank of claim 47, wherein the adapter plate comprises retention grips located around the opening in the adapter plate and configured to snap onto the gauge head, by which retention grips the adapter plate is attached to the gauge head.

50. The tank of claim 47, wherein the exterior gauge component further comprises an assembly located within the second molded piece configured to detect a rotational orientation of the tank magnet located within the tank at the gauge head.

51. The tank of claim 50, wherein the assembly located within the second molded piece comprises a rotary encoder wheel magnetically coupled with the tank magnet through the exterior wall and configured to rotate with rotation of the tank magnet such that specific ranges of rotational orientation of the tank magnet each corresponds to a specific output of the rotary encoder wheel, and wherein one of the components of the printed circuit board comprises an optical sensor configured for reading an output of the rotary encoder wheel.
